(19) United States
(12) Patent Application Publication
(10) Pub. No.: US 2015/0285760 A1
(43) Pub. Date: Oct. 8, 2015

(54) DIELECTROPHORETIC DEVICE FOR ANALYSIS OF CELL MECHANICS

(71) Applicants: Alisa Morss Clyne, Ardmore, PA (US); Rebecca Urbano, Philadelphia, PA (US)

(72) Inventors: Alisa Morss Clyne, Ardmore, PA (US); Rebecca Urbano, Philadelphia, PA (US)

(73) Assignee: DREXEL UNIVERSITY, Philadelphia, PA (US)

(21) Appl. No.: 14/642,799

(22) Filed: Mar. 10, 2015

Related U.S. Application Data
(60) Provisional application No. 61/974,151, filed on Apr. 2, 2014.

(51) Int. Cl. G01N 27/447

(52) U.S. Cl. CPC G01N 27/447

(57) ABSTRACT

A quadrupole dielectrophoresis device including at least one quadrupole electrode and a matrix patterned with at least one microspot comprising a cell-adherent protein. The quadrupole electrode is positionable to exert a dielectrophoretic force on a cell adhered to the microspot and at least one property of the cell is determined during exertion of the dielectrophoretic force. The quadrupole dielectrophoresis device may include an electric cell-substrate impedance sensing system for measuring cell deformation. A plurality of microspots and quadrupole electrodes may be provided in the device in which case the quadrupole electrodes may be multiplexed to simultaneously exert the same or different forces on different cells adhered to different microspots. Methods of using the quadrupole dielectrophoresis device to analyze cell mechanics are also provided.

### BACKGROUND OF THE INVENTION

1. Field of the Invention

The present invention is directed to the field of dielectrophoretic devices for manipulation of cells or particles. In particular, the present invention is directed to a dielectrophoretic device for manipulating cells that can be used to analyze the mechanics of cells adhered to a surface.

2. Description of the Related Technology

Cell mechanics play a critical role in healthy cell and tissue function. Cell mechanics is similarly important in numerous pathologies. Irregular shear stress leads to atherosclerotic plaque formation in arterial bifurcations, osteoarthritic chondrocytes exhibit altered mechanical responses, and decreased red blood cell deformability can lead to vascular complications in sickle cell anemia.

Both externally applied and internally generated forces impact cell structure and function, with mechanical factors contributing to signal transduction pathways, gene expression, and stem cell differentiation. While physical forces are increasingly recognized as important in biological systems, we have yet to fully understand how these forces impact biological processes at size scales ranging from gene to protein to cell to tissue. The development of new technologies enabling the study of single cell mechanics is continually broadening our understanding of the effect of forces on cellular function.

A wide variety of methods exist to test cell mechanics. Cells can be exposed to global loading, in which whole cell properties are measured through techniques such as micropipette aspiration, optical tweezers, and the optical stretcher. Alternatively, local cell loading can be used to measure the mechanical properties of specific cellular regions through techniques such as magnetic bead microrheometry, magnetic twisting cytometry, and atomic force microscopy.

Recently, dielectrophoresis (DEP) based methods have been used for manipulating cells or particles. When the object is placed in an electric field, charges on the body of the object appear in a dipolar distribution across its body. In a uniform electric field, this dipolar charges cause no net force to the object. However, in a spatially non-uniform electric field, the forces exerted on each dipole end are unequal, leading to a net force on the object. Such net force may be used to manipulate objects such as cells or particles. If the object is less polarizable than the medium it is in, the overall effective net force draws the object towards the field minimum (negative DEP, see FIG. 1).

US 2012/0085649 discloses a DEP device 100 for separation and analysis of particles in a solution, such as separation and isolation of cells of different types. The device comprises a sample channel and electrode channels, separated by an insulating barrier. The sample channel and electrode channel are each on a substrate layer. The substrate layer may be made from glass or polyimide. The electrodes of this DEP device 100 may be arranged as an array of thin-film interdigitated electrodes placed within the flow of the sample channel to generate a non-uniform electric field that interacts with particles near the surface of the electrode array, which may be an array of interdigitated sawtooth electrodes. The impedance of cultured cells is measured as the cells flow through the sample channel.

Manomohan et al. (“Design of a dielectrophoretic mechanical testing device,” MRS Proceedings, 2008:1097) discloses a DEP device 100 with three sets of quadrupole electrodes printed on a glass substrate for trapping cells and allowing the cells to attach to the glass substrate. The device may include microfluidics to allow tests on migrating cells in the fluid flow. The electrode size, electrode spacing, voltages and frequencies may be varied to create different trapping strengths. The device was fabricated using microfabrication techniques, by coating glass slides with Futurrex photoresist and exposing the coating to UV light through a chrome photo mask. The exposed photoresist was removed, leaving a patterned photoresist. Titanium and gold were sequentially deposited using electron beam evaporation, and finally excess metal and photoresist were removed using a lift-off process. In operation, individual cells in suspension are trapped by the electric field and caused to attach to the glass substrate. However, cell viability was compromised by this procedure when the electric filed was too high. The device was used to measure cell displacement using images from a microscope.

US 2007/0119714 discloses a measuring apparatus for analyzing at least one object. The device includes a fluidic microsystem having a compartment containing at least one electrode arrangement; a detector device adapted to measure electric, geometric and/or optical properties of the object; and a field forming device comprising at least one high-frequency generator. The apparatus provides impedance measuring electrodes and a detector device with a microscope and a camera. The electrodes are arranged as cage electrodes with four at the bottom and four on the top. The electrodes are placed above a substrate.

U.S. Pat. No. 7,081,192 discloses a DEP device 100 for manipulating a moiety or molecule in a microfluidic channel by electrophoretic forces generated from an electrode array, which may be an interdigitated, castellated electrode array. The device may be on a chip (as substrate) with some patterns. The moieties that can be manipulated by the device include cells, cellular organelles, viruses, molecules (e.g., proteins, DNAs and RNAs). These moieties may be separated, concentrated, transported, or selectively manipulated in the microfluidic channel.

Voldman (“Electrical forces for microscale cell manipulation,” Annu. Rev. Biomed. Eng., vol. 8, pages 425-454 (2006)) reviews various devices that use dielectrophoretic forces for microscale cell manipulation. For example, on page 435, third paragraph and in FIG. 3(a), the article cites an electrode array in a fluid channel that can separate different cell types based on dissimilar polarity of the cells such that one cell type is attracted to the electrodes and the others are repelled from the electrodes. The article also discloses a device comprising two quadrupole electrodes, with one on the top of the other to confine or trap particles (see FIG. 6 and page 441, second last paragraph).

These existing technologies are either inherently low through-put, incapable of testing adherent cells, or require attachment of beads to the cells through interaction with membrane proteins, which could result in unwanted activation of signaling pathways. The present invention provides an improved DEP device 100 that could deform a well-attached cell that may be quantified by image analysis. This DEP device 100 provides an inexpensive, non-contact tool to measure global attached cell mechanics.

### SUMMARY OF THE INVENTION

In one aspect, the present invention provides a multiplexed quadrupole dielectrophoresis device, comprised of an electrode array arranged as one or more quadrupole electrodes and a matrix patterned with microspots of a protein.

In another aspect, the multiplexed quadrupole dielectrophoresis device of the present invention comprises an electrode array of three quadrupole electrodes.

In yet another aspect, the multiplexed quadrupole dielectrophoresis device of the present invention comprises a matrix having different stiffnesses in different areas.

In yet another aspect, the multiplexed quadrupole dielectrophoresis device of the present invention comprises a matrix with a stiffness that gradually increases from one end to the other.

In yet another aspect, the multiplexed quadrupole dielectrophoresis device of the present invention comprises a matrix having one set of microspots comprising one protein and a different set of microspots comprising a different protein.

In yet another aspect, the multiplexed quadrupole dielectrophoresis device of the present invention comprises an electric cell-substrate impedance sensing system for measuring cell deformation.

In yet another aspect, the multiplexed quadrupole dielectrophoresis device of the present invention comprises a phase contrast microscope for measuring cell deformation.

In yet another aspect, the multiplexed quadrupole dielectrophoresis device of the present invention comprises a gradient microfluidic chamber with an inlet and an outlet.

In yet another aspect, the present invention provides methods of analyzing cell mechanics of an adhered cell using the multiplexed quadrupole dielectrophoresis device of the present invention. The method may be used for diagnosing cancers, evaluating cell contractility, e.g. of cardiac myocites and other muscle cells, and measuring stem cell differentiation, since cancers, cell contractility and stem cell differentiation may correlate with cell stiffness. The method includes steps of: adhering at least one cell to at least one microspot of the quadrupole dielectrophoresis device of the present invention, applying a voltage to at least two of said four electrodes of each said quadrupole electrode to exert a dielectrophoretic force on said at least one adhered cell, and determining at least one property of said cell during exertion of said dielectrophoretic force.

### BRIEF DESCRIPTION OF THE DRAWINGS

FIG. 1 is a diagram showing a dielectrophoretic force exerted on a polarized cell generated by a non-uniform electric field.

FIG. 2A shows an electrode array with three quadrupole electrodes located side-by-side on a glass substrate.

FIGS. 2B and 2C are two different sized enlarged views of the inset in FIG. 2A, showing the tips of the quadrupole electrode forming a cage.

FIG. 2D is a diagram showing a multiplexer/controller for sending multiplexed signals to three quadrupole electrodes.

FIG. 3 shows a quadrupole electrode deposited on a glass substrate.

FIG. 4A shows polyacrylamide gel matrices provided with micro-patterns of protein spots.

FIG. 4B shows cells attached to the protein spots of the polyamide gel matrices of FIG. 4A.

FIG. 4C shows an immunofluorescent image of a location where a single cell is attached to a microspot. The cell was fixed and labeled to show its actin and focal adhesion (showing that the cell is strongly attached).

FIG. 5 is a diagram that shows a process for producing a micro-patterned matrix, according to one embodiment of the present invention.

FIG. 6 shows a dielectrophoresis device in accordance with the present invention set up for analyzing the mechanics of a cell adhered to a matrix.

FIG. 7A shows the situation when operation of the device begins and equal voltage is being applied to the opposing electrodes and no directional pushing force is generated. This is an example of a cropped brightfield image of an attached cell in the center of the device at the start of device operation.

FIG. 7B shows generation of a pushing force in the direction of the arrow. The images are then processed to isolate the pixels belonging to the cell.

FIG. 7C shows the pixels belonging to the cell in FIG. 7A in gray. The outline of the cell of FIG. 7B is shown in white to show the change in the position from FIG. 7A after the pushing force is applied.

FIG. 8 shows a dielectrophoresis device according to an alternative embodiment of the present invention.

FIG. 9 shows cell centroid movements towards a low voltage electrode as a result of the application of a dielectrophoretic force to the cell. The centroid movements are an indication of cell deformation in response to a non-uniform electric field. The distance of the centroid movement grows larger as the dielectrophoretic force is increased by application of a larger voltage difference between electrodes across from each other as in the right side of FIG. 9.

FIG. 10A is a plot showing how cytochalasin D treatment increased centroid movement of adhered cells subject to a dielectrophoretic force, in comparison with untreated adhered cells subjected to the same dielectrophoretic force.

FIG. 10B shows, under application of three different DEP forces, that cytochalasin D treatment decreases cell stiffness thereby increasing cell deformation.

FIG. 10C shows that the cell modulus in cytochalasin D treated cells is lower than in the untreated cells, as observed by atomic force microscopy (AFM).

FIG. 11A shows centroid movement for both normal (MCF10A) and cancerous (MCF10A-Neu T) adhered cells when exposed to dielectrophoretic forces.

FIG. 11B shows that at different dielectrophoretic forces, one type of cancerous cell (MCF10A-Neu T) exhibited decreased cell stiffness thereby increasing cell deformation, as compared to the corresponding type of normal cell (MCF10A).

FIG. 11C shows that the cell modulus in one type of cancerous cell (MCF10A-Neu T) is lower than the cell modulus of the corresponding type of normal cell (MCF10A), as observed by AFM.

FIG. 12 shows that TNF-α treated cells have a higher elastic modulus than untreated cells, as observed by AFM.

FIG. 13 is a flow chart showing a method of analyzing cell mechanics according to one embodiment of the present invention.

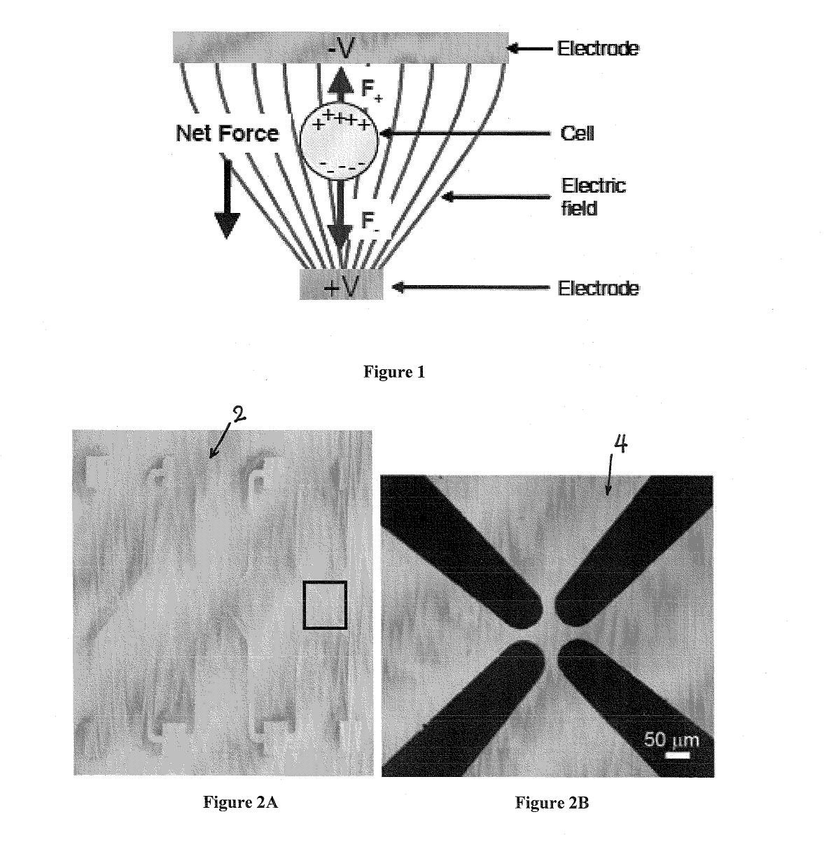

### DETAILED DESCRIPTION OF THE PREFERRED EMBODIMENT(S)

For illustrative purposes, the principles of the present disclosure are described by referencing various exemplary embodiments. Although certain embodiments are specifically described herein, one of ordinary skill in the art will readily recognize that the same principles are equally applicable to, and can be employed in, other systems and methods. Before explaining the disclosed embodiments of the present disclosure in detail, it is to be understood that the disclosure is not limited in its application to the details of any particular embodiment shown. Additionally, the terminology used herein is for the purpose of description and not of limitation. Furthermore, although certain methods are described with references to steps that are presented herein in a certain order, in many instances, these steps may be performed in any order as may be appreciated by one skilled in the art; the novel method is therefore not limited to the particular arrangement of steps disclosed herein.

It must be noted that as used herein and in the appended claims, the singular forms “a”, “an”, and “the” include plural references unless the context clearly dictates otherwise. Furthermore, the terms “a” (or “an”), “one or more” and “at least one” can be used interchangeably herein. The terms “comprising”, “including”, “having” and “constructed from” can also be used interchangeably.

The present invention provides a multiplexed quadrupole dielectrophoresis (DEP) device 100 comprised of an electrode array 2 having one or more quadrupole electrodes 4, a matrix 6 provided with one or more microspots 8, and optionally, an electric cell-substance impedance sensing system to measure cell impedance. The cell impedance is a way of gauging cell deformation. Dielectrophoretic forces of different magnitudes may be generated by the electrodes and applied to one or more cells adhered to the microspots 8. The subsequent cell deformation may optionally be quantified by the impedance sensing system. The DEP device 100 provides an inexpensive, non-contact tool to analyze the cell mechanics of adhered cells. This DEP device 100 can also be used to study the mechanics of multiple cells in a high throughput fashion.

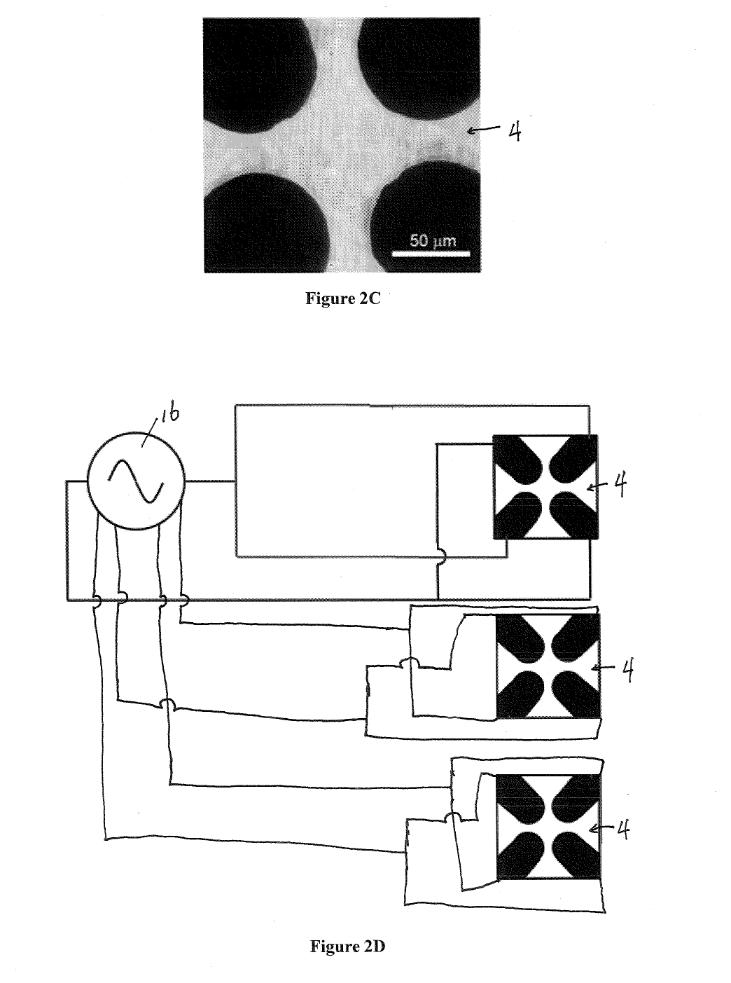

The term “multiplexed” as used herein referred to the fact that the device is multiplexed to send signals to a plurality of quadrupole electrodes 4 (FIG. 2D). A multiplexer/controller 16 may be used to generate the multiplexed signals to be sent to the quadrupole electrodes 4 for parallel control and data collection from multiple cells simultaneously, thus allowing operation in a high throughput fashion. The DEP device of the present invention may be multiplexed in some embodiments.

The DEP device 100 includes an electrode array 2 with one or more quadrupole electrodes 4. When multiple quadrupole electrodes 4 are present in the array, the quadrupole electrodes 4 may be arranged side to side as shown in FIG. 2A. The electrode array 2 may have two or three or more quadrupole electrodes 4 placed side by side, as shown in FIG. 2A. FIGS. 2B and 2C show two different sized enlargements of the tips of one of the quadrupole electrodes 4 of FIG. 2A. The quadrupole electrodes 4 form a cage between the tips of the electrodes. During operation of the DEP device 100, the quadrupole electrode positioned a small distance above the adhered cell with the adhered cell located within the cage, preferably at the center of the cage, for application of DEP forces to the cell and analysis of the cell's mechanics.

The voltages applied to the quadrupole electrodes 4 generate a dielectrophoretic force upon the adhered cells at the center of the quadrupole electrodes 4. When the voltage is applied equally across two opposing electrodes, an equal dielectrophoretic force is generated on each side of the cell in opposite directions, resulting in no net force across the cell. However, when the voltage to one electrode is reduced (proportional to increasing the resistance to that electrode), the dielectrophoretic force near the high voltage electrode becomes larger than the force near the low voltage electrode, resulting in a net pushing force on the cell towards the low voltage electrode.

The height of the quadrupole electrodes 4 above the cells also affects the dielectrophoretic force on the adhered cells. In some embodiments, the dielectrophoretic force may be near constant if the quadrupole electrodes 4 are lower than a threshold height above the adhered cells. This threshold height may vary according to the specific embodiment of the DEP device 100. However, when the quadrupole electrodes 4 are above the threshold height, the dielectrophoretic force decreases as the height increases.

Each electrode of the DEP device 100 may include an electrically conductive layer of one or more biocompatible conductive materials selected from silver, gold, cobalt, chromium, copper, iron, iridium, aluminum, nickel, tantalum, titanium, tungsten, titanium, platinum, palladium, vanadium, tantalum oxide, titanium oxide, chromium oxide, vanadium oxide, magnesium oxide, and indium tin oxide.

The quadrupole electrodes 4 may be manufactured using standard microfabrication techniques on a glass substrate. In one exemplary fabrication technique, a glass substrate may be selected for the DEP device 100 for allowing microscopic observation of the cells through the substrate. A photomask of the designed electrodes may be printed at high resolution onto a transparent film to make a transparent mask (e.g. from JD Photo-Tools). 4″×4″ chrome plates pre-coated with negative SU-8 photo resist can be used (from Telic). SU-8 is a commonly used epoxy-based negative photoresist. The chrome plate is exposed to ultraviolet light through the transparent mask, baked, and developed to produce a patterned chrome mask. The chrome mask is then used to create the electrodes by sequential deposition of titanium and gold using, for example, physical vapor deposition in a thermal evaporator (Thermionics VE 90) at 20 nm and 200 nm thickness, respectively.

The thickness of the electrode may then be increased to a thickness within the range of from about 0.6 μm to about 1.4 μm, or from about 0.7 μm to about 1.3 μm, or from about 0.8 μm to about 1.2 μm, or from about 0.9 μm to about 1.1 μm, or from about 0.95 μm to about 1.05 μm, by gold electroplating. In one embodiment, the glass substrate with electrodes is then submerged in non-cyanide gold electroplating solution (Technigold 25E RTU, Technic) maintained at 60-70° C. with constant stirring. Gold is deposited by pulse plating (500 mVpp) with a 10% duty cycle using a function generator (BK Precision 4010) at a rate of ˜0.013 μm/minute. Final electrode thickness following the electroplating may be measured by optical profilometry (Zygo NewView 6000).

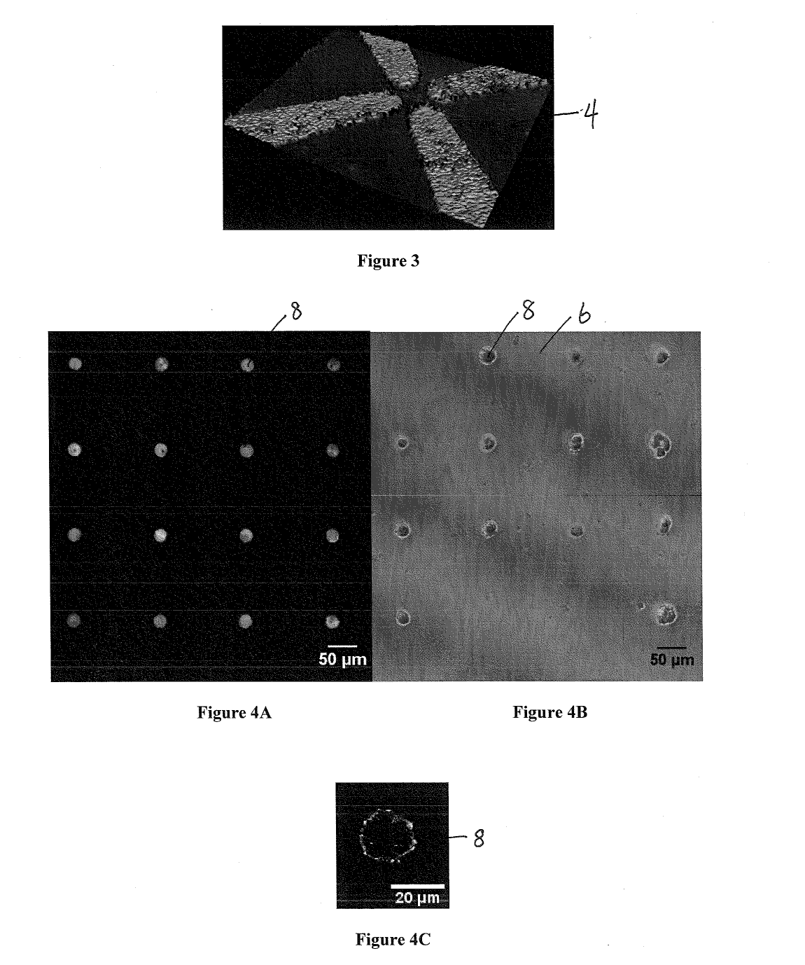

In some embodiments, the electrode array 2 may consist of multiple quadrupole electrodes 4 configured on a single glass substrate. The electrodes of each quadrupole electrode may increase in width as they extended outward from the tips, preferably at a 45° angle, and finally attach to an electrode pad as shown in FIG. 2D. The magnified images of FIGS. 2B-2C of the quadrupole electrode show rounded electrode tips. Electrical leads to the quadrupole electrodes 4 may be created by soldering copper wire strands onto the electrode pads. The soldered pads may be further strengthened and sealed by curing a thin layer of polydimethlysiloxane (PDMS) over the electrode pads as shown in FIG. 3.

Each quadrupole electrode has four opposing electrodes forming a three-dimensional central space where DEP forces can be controlled, referred to as a “cage.” The electrodes are lowered from above a single adhered cell to a position slightly above the adhered cell whereby the adhered cell is located in the cage and thus centrally positioned in a horizontal plane relative to the electrode tips. Two opposing electrodes are defined as ground. The voltage of one electrode may be maintained at 21 Vpp and the voltage of the last electrode may be varied between 8.3 and 20 Vpp at 1 MHz. The DEP force generated by a quadrupole electrode is defined as:

F_{DEP}=2π∈ₘR³Re[CM(ω)]∇|E|²

For a uniform spherical particle in the cage, the Clausius-Mossotti factor is defined as:

$$\underline{CM} = \frac{{\underline{ɛ} }_{p} - {\underline{ɛ}}_{m}}{{\underline{ɛ}}_{p} + {\underline{2 ɛ}}_{m}}$$

where ∈ₚ and ∈ₘ are the complex permittivity's of the particle and the medium, respectively. The complex permittivity is given by:

$$\underline{ɛ} = ɛ + \frac{σ}{j ω}$$

where ∈ is the permittivity and a is the conductivity. At 1 MHz, the Clausius-Mossotti factor is negative. Therefore, a polar and spherical particle in the cage of quadrupole electrodes 4 experiences a negative dielectrophoretic force.

The matrix 6 of the DEP device 100 provides a surface for cells to be adhered to. The matrix 6 comprises a material selected from glass, quartz, and polymers. The polymers are flexible and biocompatible, including polymers that are either three dimensional or linear, or any combination thereof. Suitable polymers include flexible, biocompatible polymers such as natural polymers, derivatives of natural polymers, synthetic polymers, biopolymers, and the like, or any mixtures thereof. Some non-limiting examples of suitable polymers include extracellular matrix materials such as collagen gels, gelatin gels, alginates, fibrin gels and Matrigel®, guar gums, high-molecular weight polysaccharides composed of mannose and galactose sugars, or guar derivatives such as hydropropyl guar (HPG), carboxymethyl guar (CMG), and carboxymethylhydroxypropyl guar (CMHPG). Cellulose derivatives such as hydroxyethylcellulose (HEC) or hydroxypropylcellulose (HPC) and carboxymethylhydroxyethylcellulose (CMHEC) may also be used in either crosslinked form, or without crosslinker in linear form. Xanthan, diutan, and scleroglucan are three biopolymers that have been shown to be useful as well. Synthetic polymers include, but not limited to, polyacrylamide, polyvinyl alcohol, polyethylene glycol, polypropylene glycol, polyacrylic acid, polyethyleneterephtalate, polysulfone polymethylmethacrylate, polyimide and polyacrylate polymers, and the like, as well as copolymers thereof.

As shown in FIGS. 4A-4B, the matrix 6 comprises one or more microspots 8 on its surface, with each microspot 8 having a size sufficient for adherence of a single cell. Each microspot 8 comprises protein for the cell to adhere to. The space between microspots 8 may be from about 50 μm to about 200 μm, or from about 70 μm to about 150 μm, or from about 80 μm to about 130 μm, or from about 90 μm to about 120 μm, or from about 100 μm to about 110 μm in order to provide sufficient room to surround the microspot 8 with the quadrupole electrode tips.

Each microspot 8 comprises at least one protein suitable to securely adhere a cell to the microspot 8 as shown in FIG. 4C. Microspots 8 are useful to control cell spreading. The matrix 6 surface surrounding the one or more microspots 8 preferably does not have protein on its surface to reduce or prevent cell adhesion to the matrix 6 outside of the microspots 8. The proteins that may be used for the microspots 8 may be selected from, for example, collagen I, collagen III, collagen IV, collagen VI, fibronectin, vitronectin, laminin, tenascin, fibrin, cadherin, filamin A, vimentin, decorin, tenascin C, osteopontin, and combinations thereof. In some embodiments, adhesive peptides may be used for the microspots 8. The adhesive peptides may be part of a protein that cells can adhere to, such as an Arginine-Glycine-Aspartic Acid (RGD) peptide.

In one embodiment, the matrix 6 is a polyacrylamide gel provided with one or more microspots 8 on the surface thereof. In one embodiment, the microspots 8 may comprise human plasma fibronectin.

In some embodiments, the matrix 6 may be provided with one or more protrusions and one or more microspots 8 may be provided on the surfaces of the one or more protrusions. The protrusions may be sized to hold a cell and enable the DEP device 100 to be more easily lowered over the cells.

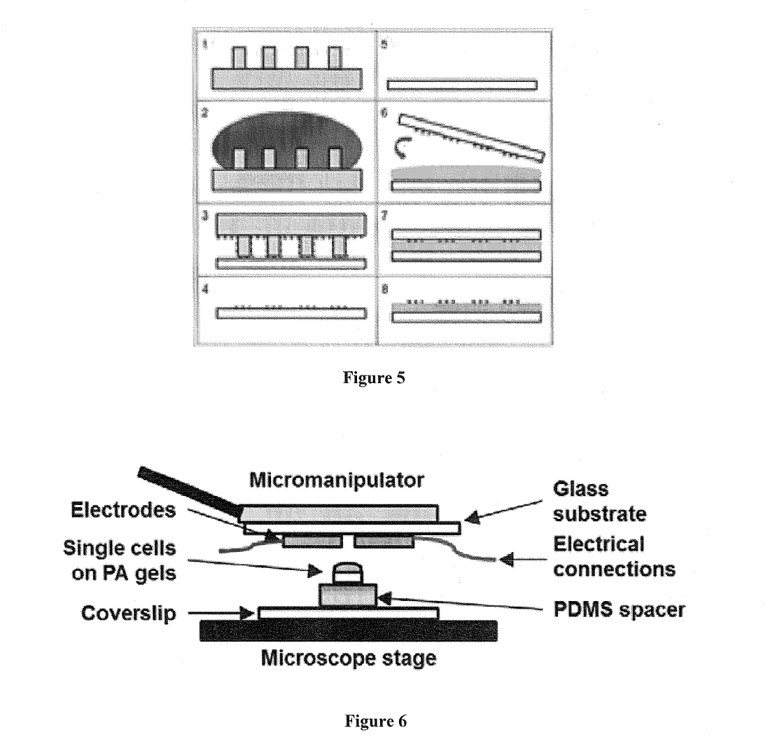

In some embodiments, the matrix 6 may be manufactured by microcontact printing of microspots 8 on a polyacrylamide gel as shown schematically in FIG. 5. In this embodiment, a patterned microspot (PDMS) stamp may be made using standard soft photolithography methods (panel 1 in FIG. 5). The PDMS stamp may then be incubated with a solution of a protein such as fibronectin for a period from about 20 minutes to about 80 minutes, or from about 30 minutes to about 70 minutes, or from about 30 minutes to about 60 minutes, or from about 35 minutes to about 50 minutes (panel 2 in FIG. 5). The PDMS stamp is then removed from the protein solution leaving a coating of protein on the surfaces of the PDMS stamp. The PDMS stamp may then be immediately placed onto a plasma-cleaned glass top coverslip (panel 3 in FIG. 5), to transfer the pattern of protein microspots from the PDMS stamp to the top coverslip (panel 4 in FIG. 5). An acrylamide solution that is in the process of polymerizing is placed on a bottom coverslip (panels 5 and 6 in FIG. 5). The micropatterned top coverslip may then be inverted over the acrylamide solution, followed by completion of the polymerization of the acrylamide in the solution to form a polyacrylamide gel (panel 7 in FIG. 5). After removing the top coverslip, the surface of the polyacrylamide gel is patterned with microspots of protein transferred from the top coverslip to the polyacrylamide gel during the polymerization process (panel 8 in FIG. 5).

In some embodiments, the matrix 6 may have a different stiffness at different locations. Such a matrix 6 may be manufactured by sequential polymerization at different locations to generate polymerized materials with different stiffness and/or other different characteristics. In these embodiments, the cells located at different location may experience different matrix stiffness and/or other characteristic thereby allowing the cells to be analyzed when exposed to different matrix conditions.

In some embodiments, the microspots 8 on the matrix 6 may comprise different proteins. Multiple different proteins may be used for microspots 8 on the same matrix 6. In these embodiments, the cell to be measured may be adhered to different proteins at different microspots 8 thereby permitting analysis of cell mechanics when adhered to different proteins.

The quadrupole electrodes 4 may be affixed to a micromanipulator and lowered over the matrix 6 provided with adhered cells. Each cell is positioned at a central location relative to the cage of a quadrupole electrode 4, preferably at the center of the cage as shown in FIG. 6. The quadrupole electrode 4 is lowered to a location which is a small distance above the cell of, for example, about 10 microns.

An electric potential is applied via diagonally opposing electrodes as shown in FIG. 2D. When no extra resistance is applied, both electrodes receive the same voltage. Increasing resistance for one electrode decreases the voltage to that electrode and therefore changes the magnitude and/or direction of the DEP force exerted on the cell. In some embodiments, a DEP force was applied for 15 seconds using unequal voltage across the electrodes, followed by 15 seconds using an equal voltage across the electrodes.

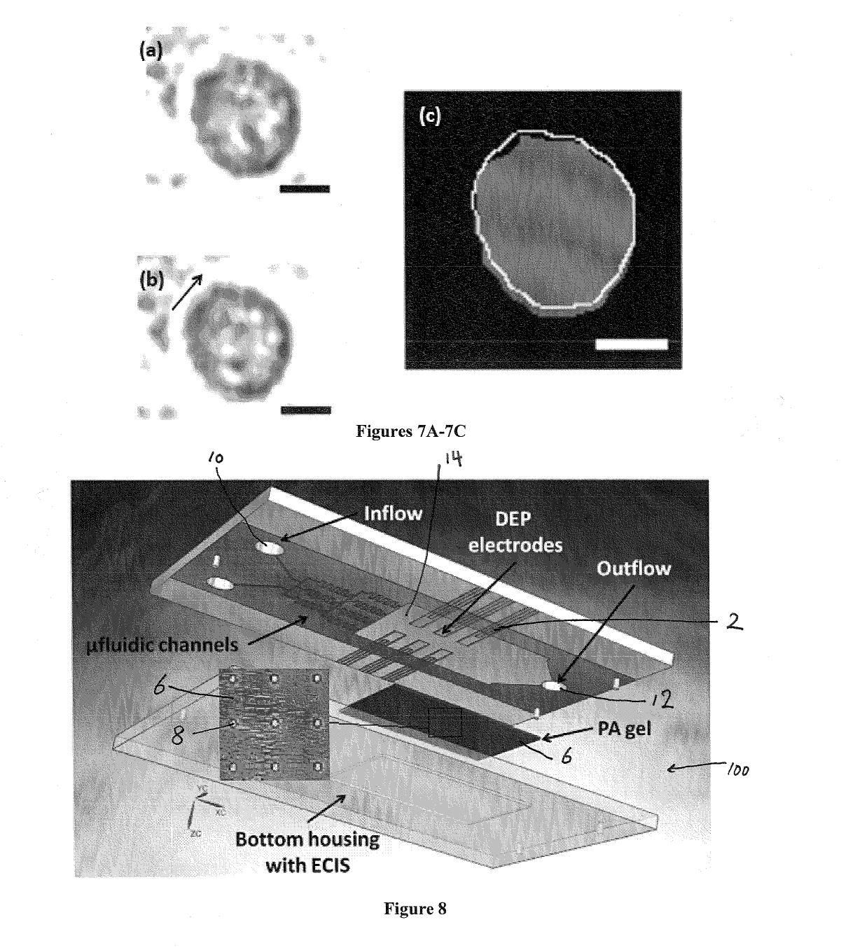

In some embodiments, the matrix 6 is flexible. The flexural modulus of the matrix 6 may be in a range of from about 2 to about 500 kPa, or from about 20 to about 400 kPa, or from about 30 to about 300 kPa, or from about 50 to about 200 kPa. When a cell is adhered to a flexible matrix 6, the position of the cell may be changed slightly by using external force. When the adhered cell is not centered in the cage of a quadrupole electrode 4, the DEP force may first be used to move the cell to the center of the cage (FIG. 7A). Then, a DEP force may be applied using unequal voltage across the electrodes to the centered cell to cause cell deformation (FIG. 7B).

In these embodiments, the use of flexible matrix 6 can allow for some misalignment between the matrix 6 and the surface of a quadrupole electrode 4. The misalignment can be compensated by the flexibility of the matrix 6 which can allow a limited amount of movement of the surface of the matrix 6 in order to be able to align the surface of the matrix 6 with the surface of the quadrupole electrode 4. It is desirable to have the surface of the matrix 6 and the surface of the quadrupole electrode 4 to be parallel. For example, when the quadrupole electrode 4 is lowered over the matrix 6 (where the cell is attached), the two surfaces may not be completely parallel. As the quadrupole electrode 4 gets closer and closer to the matrix 6, the matrix 6 deforms and allows the quadrupole electrode 4 to be located within a very small distance from the cell on the matrix 6.

In some embodiments, the DEP device 100 comprises an electric cell-substrate impedance sensing (ECIS) system for measuring cell deformation (i.e., cell shape changes). When using an ECIS system, a low alternating current (I) is applied across the electrodes of the ECIS system. The ECIS system measures the resultant potential (V) across the electrodes, and then the frequency-dependent impedance (Z) is calculated from Z=V/I. When cells attach to the electrodes and/or change their morphology by, for example, deformation, the impedance changes since the cells act as insulators. By measuring impedance over time, the ECIS system can detect cell morphology changes such as cell deformation on a nanoscale or microscale.

In this manner, cell deformation may be quantified through measurement of low frequency impedance, which correlates to the relative distance between the electrode and the edge of the cell, or through high frequency impedance, which correlates to the overall cell thickness. Due to the insulating properties of cell membranes, cells behave like dielectric particles so that the impedance of the cell changes in response to the applied potential. The measured impedance is mainly determined by the three-dimensional shape of the cells. If the cell changes its three-dimensional shape, the current pathways through and around the cell change, leading to a corresponding increase or decrease in the measured impedance. Thus, by recording time-resolved impedance measurements, cell shape changes can be followed in real time with sub-microscopic resolution.

The DEP forces at the center of a quadrupole electrode cage when different voltages are applied to one of the quadrupole electrodes are shown in Table 1.

TABLE 1
DEP force at the center of a quadrupole electrode cage

| Resistance | Voltage 1 | Voltage 2 | Predicted DEP |
|---|---|---|---|
| (Ω) | (Vₚₚ) | (Vₚₚ) | force (nN) |
| 100 | 21 | 20.7 | 0.01 |
| 200 | 21 | 20.5 | 0.02 |
| 300 | 21 | 20.3 | 0.03 |
| 400 | 21 | 19.8 | 0.06 |
| 1000 | 21 | 17.8 | 0.15 |
| 2000 | 21 | 13.6 | 0.30 |
| 3000 | 21 | 10.7 | 0.39 |
| 4000 | 21 | 8.3 | 0.44 |

Impedance measurements may be taken continuously as an adhered cell is deformed by the DEP force. The ECIS system may also determine electrical property changes in the cell. This can be done, for example, using different cell types, with a biochemical agent. Thus, the ECIS system enables quantitative cell deformation measurements and ensures use of accurate cell electrical properties in DEP calculations. More details of the ECIS system are described in, for example, EP 1 692 258 A2, WO 2008/131609 A1, U.S. Pat. No. 8,344,742, and US 2012/0288922 A1, each of which are incorporated by reference herein in their entirety.

In some embodiments, cell deformation may be imaged by a phase contrast microscope. More specifically, bright-field images may be taken at intervals such as every 0.5 seconds. The bright-field images may be converted to binary black and white dots. The converted images may be processed to quantify cell deformation by measuring the distance between the cell body centroid and a fixed spot on the image boundary. When a DEP force is applied to the adhered cell, the distance between the cell body centroid and the fixed spot may change, indicating cell deformation. For example, if the device is set up so that the cell is being pushed toward the upper right corner of the image, the position of the cell body is determined with respect to the lower left corner of the image (FIGS. 7A-7C). All measurements may be normalized relative to the initial position of the cell.

In some embodiments, the DEP device 100 may comprise a microfluidic chamber 14 with an inlet 10 and an outlet 12 as shown, for example, in FIG. 8. The microfluidic chamber 14 may be used to expose the cells adhered to the matrix 6 to soluble factors in a solution. Using the microfluidic chamber 14, various substances such as biomolecules, chemicals, pharmaceuticals and mixtures thereof may be used to treat the adhered cells prior to or during analysis using the DEP device 100. Also, the microfluidic chamber 14 may be used to expose adhered cells to forces caused by liquid flow relative to the matrix 6 to induce, for example, shear stress on the adhered cells. Cell responses to the various treatments, as well as changes in cell deformation induced by the various treatments may be measured in real time.

The substances may be introduced through the inlet 10 into the microfluidic chamber 14, where the cells adhered to the matrix 6 come into contact with the substances. Cell mechanical properties are important in mechanoresponsive organ systems, cell development, and cell pathology. Dynamic changes in cell mechanical properties measured using such DEP device 100 may play an important role in basic medical research, disease diagnosis and pharmaceutical development.

In some embodiments, a gradient microfluidic chamber 14 provided with mixing channels for producing fluids with different concentrations of a substance may be employed. In this manner, the adhered cells may be exposed to the substance at different concentrations. In pharmaceutical research, drugs or drug candidates may be introduced to the gradient microfluidic chamber 14 for measuring responses of the cells to the drugs or drug candidates at different concentration levels. Toxicity or efficacy of the drugs or drug candidates may be efficiently measured in this manner by using the DEP device 100 of the invention provided with a gradient microfluidic chamber 14.

The microfluidic chamber 14 may be manufactured from a 50 μm thick SU-8 layer by photolithography. A dual syringe pump may be used to provide two stock solution flows that mix in the gradient chambers to create four different concentrations of the introduced substance, each of which may be independently used to stimulate the adhered cells as shown in FIG. 8. In this embodiment, the microfluidic chamber 14 may be located on the same substrate as the quadrupole electrodes 4 such that the quadrupole electrodes 4 are integrated in the microfluidic chamber 14. By including the gradient microfluidic chamber 14 in the DEP device 100, adhered cells can optionally be exposed to different substance concentrations.

In some embodiments, the alignment of the cell (attached to a microspot 8) to the center of the quadrupole electrode “cage” is done manually using a micromanipulator. Alternatively, an alignment mechanism may be included in the DEP device 100 that can automatically align the microspot 8 with the center of the quadrupole electrode cage. Thus, the present invention can position the cells in alignment with the quadrupole electrodes 4 after the cells are attached to the microspots 8. In addition, the use of microspots 8 allows control of the size and location of the cell. Thus, the microspots 8 enable comparison across multiple cells that are all spread the same amount, as well as placing the cells in a specific location.

Further, the matrix 6 may be flexible, thus providing the ability to further compensate for slight misalignment of the matrix 7 with the surface of the quadrupole electrodes 4 since the flexible matrix 6 allows certain amount of flexibility to force alignment of the matrix 6 parallel to the surface of the quadrupole electrodes 4. When cell spreading is limited by the microspots 8, a smaller force is needed to deform the cell and therefore smaller voltages can be used to deform the cell. The microspots 8 also enable direct comparisons between cell measurements. These features enable the DEP device 100 to be used in wider range of applications. For example, the DEP device 100 may be used to, for example, differentiate drug sensitive from drug resistant cancer cells, precursor cells from differentiated stem cells, and young red blood cells from old red blood cells.

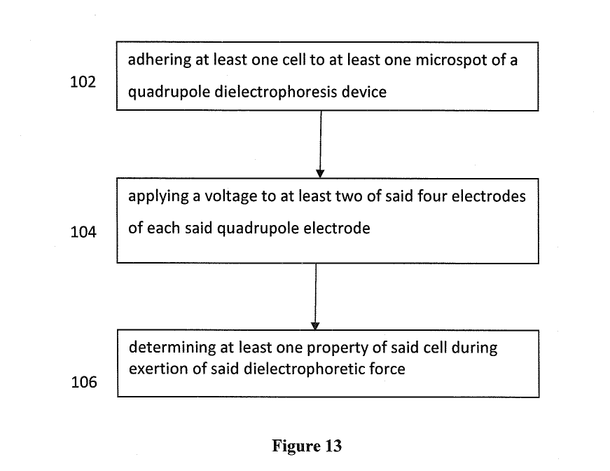

In another aspect, the present invention provides a method for analyzing cells, including the steps of: adhering 102 at least one cell to at least one microspot of the quadrupole dielectrophoresis device 100 of the present invention, applying 104 a voltage to at least two of said four electrodes of each said quadrupole electrode 4 to exert a dielectrophoretic force on said at least one adhered cell, and determining 106 at least one property of said cell during exertion of said dielectrophoretic force (FIG. 13). In some embodiments, the method further comprises a step of exposing the at least one adhered cell to a substance or fluid flow prior to or during said determining step.

The cell properties that may be analyzed by this method may be, for example, electrical properties including resistance, capacitance and impedance, or mechanical properties including stiffness, deformability and Poisson's ratio. In one embodiment, the analyzed property is cell deformation. In another embodiment, the analyzed property is impedance of the cells.

The DEP device 100 of the present invention may be used in diagnostics, for example, to diagnose various diseases. It is known that the mechanical environment plays an important role in tissue and cell health and disease across physiological systems. Both externally applied and internally generated forces impact cell structure and function, with mechanical factors contributing to signal transduction pathways, gene expression, and stem cell differentiation. Cell stiffness in particular is critical to decreased endothelial cell nitric oxide release in hypertension, breast epithelial cell malignant transformation and metastasis, and cardiac myocyte contractile function in response to cardiotonic agents. Cell mechanics are similarly important in skeletal, respiratory, auditory, renal and cardiovascular pathology. In hypertension, elevated aldosterone increases endothelial cell stiffness, which impairs nitric oxide production and subsequent vasodilation. Metastatic breast epithelial cells are significantly less stiff than normal cells. Cardiac myocyte contractile function in response to substrate load and cardiotonic drugs can be measured through changes in cell stiffness.

The DEP device 100 enables analysis of cell mechanics, which may be used for diagnosis of diseases by identifying diseased cells, e.g. endothelial cells in hypertension, metastatic breast cancer epithelial cells (highly invasive cancer cells) and any of the other types of cells mentioned above. The DEP device 100 may also be used in drug discovery where measuring or monitoring cell mechanics that may change in response to pharmaceutical agents is desirable. For example, it may be used to examine cardiac myocyte force/velocity relationships in response to cardiotonic agents through the contraction cycle to understand drug effects on cardiac contractility.

### EXAMPLES

The following examples are illustrative, but not limiting, of the methods and devices of the present disclosure. Other suitable modifications and adaptations of the variety of conditions and parameters normally encountered in the field, and which are obvious to those skilled in the art, are within the scope of the disclosure.

### Example 1

Quadrupole electrodes 4 were manufactured using standard microfabrication techniques. Square glass substrates (2″×2″) were selected as a base to allow for cell observation using an inverted microscope. The electrode photomask was designed in a software AutoCAD and printed at high resolution onto a transparent film (JD Photo-Tools). 4″×4″ chrome plates pre-coated with negative SU-8 photo resist were purchased from Telic. A chrome plate was exposed to ultraviolet light through the photomask, baked, and developed to produce the chrome mask. The chrome mask was then used to create the electrodes by sequential deposition of titanium and gold, where titanium was used to enhance the gold adhesion to glass. Futurrex NR9-1000PY (Futurrex) was used as a photoresist with RD6 developer since it can withstand the high temperatures required for metal deposition. Titanium and gold were sequentially deposited by physical vapor deposition in a thermal evaporator (Thermionics VE 90) at 20 nm and 200 nm thicknesses, respectively.

The electrode thickness was then increased to 1 μm by gold electroplating, carried out by submerging the electrodes in a cyanide-free gold electroplating solution (Technigold 25E RTU, Technic) maintained at 60-70° C. with constant stirring. Gold was deposited by pulse plating (500 mVpp) with a 10% duty cycle using a function generator (BK Precision 4010) at a rate of ˜0.013 μm/minute. The final electrode thickness following electroplating was confirmed by optical profilometry (Zygo NewView 6000).

The fabricated quadrupole electrodes 4 consisted of three quadrupole electrodes 4 a single glass substrate. The electrodes increase in width as they extended outward from the quadrupole at a 45° angle, finally attaching to a 2 mm square electrode pad as shown in FIG. 2A. Electrical leads were created by soldering copper wire strands onto the connector pads. The soldered pads were strengthened and sealed from the cell medium by curing a thin layer of polydimethylsiloxane (PDMS, Sylgard, Dow Corning) over the connector pads.

### Example 2

A matrix 6 was fabricated in this example. PDMS stamps for microcontact printing were made using standard soft photolithography methods. Transparency film photomasks with a 25 μm diameter circle array were printed (JD Photo-Tools). SU-8 2025 (Microchem) was spin-coated on a glass substrate, soft baked, exposed for 3 minutes using a UV lamp (NuArc 26-1K Mercury Exposure System), post-exposure baked, developed in an SU-8 developer, and then hard baked. To ease PDMS release, the SU-8 mold was coated with (tridecafluoro-1,1,2,2-tetrahydro octyl)-1-trichlorosilane (UCT) by vapor deposition. PDMS was mixed using a 10:1 ratio of base to curing agent, degassed, poured onto the mold and cured at 70° C. for at least three hours.

Micropatterned polyacrylamide (PA) gels were made by indirect microcontact printing as illustrated in FIG. 5. A top coverslip was patterned with fibronectin using a PDMS stamp. Stamps were incubated with a mixture of biotinylated tetramethylrhodamine-BSA (5 μg/mL, Invitrogen™) and biotinylated human plasma fibronectin (50 μg/mL, Gibco) for 40 minutes. The stamps were then removed from the protein solution and the stamps were blown dry and immediately placed onto plasma-cleaned glass coverslips (5 mm for DEP device 100 samples or 12 mm for AFM samples) for 5 minutes. A streptavidin polyacrylamide gel solution was created by adding 0.1 mg/mL streptavidin-acrylamide (Invitrogen™) to a PA solution of 10% acrylamide (BioRad™), 0.3% bis-acrylamide (BioRad™), 1% ammonium persulfate (BioRad™), and 0.3% TEMED (BioRad™). A bottom coverslip was activated by sequential incubation in 0.1 M NaOH (Sigma Aldrich), (3-aminopropyl)trimethoxysilane (Sigma Aldrich), and 0.5% glutaradehyde (Polysciences) for 30 minutes. The streptavidin-PA solution was added to the bottom coverslip, after which the micropatterned top coverslip was quickly inverted over the polymerizing gel. Polymerization was completed in a 37° C., 5% CO₂ incubator for 15 minutes, after which the top coverslip was removed. The micropatterned PA gel was then rinsed thoroughly and stored in phosphate buffered saline (PBS) at 4° C. for a maximum of 2 days prior to use.

### Example 3

Primary porcine aortic endothelial cells (PAEC) were isolated by the collagenase dispersion method and cultured in low glucose Dulbecco's Modified Eagle's medium (DMEM, Mediatech™) supplemented with 5% fetal bovine serum (Hyclone), 1% glutamine, and 1% penicillin-streptomycin (Invitrogen™). Cells were used up to passage 8. Human mammary epithelial cells (MCF-10A) and mammary epithelial cells transformed with oncogenic activating ErbB2 mutant, NeuT (MCF-10A NeuT) were also used. Cells were maintained in DMEM/F12 (MediaTech™) supplemented with 5% horse serum, 20 ng/mL epidermal growth factor (EGF), 500 ng/mL hydrocortisone, 10 ng/mL cholera toxin, 10 μg/mL insulin, and 1% penicillin-streptomycin (Invitrogen™).

Cells were released from tissue culture dishes with trypsin, seeded onto micropatterned PA gels, and 30 minutes was allowed for the cells to attach to the microspots 8. The medium was replaced and the PA gel was washed to remove unattached cells. Cells were then incubated on the micropatterned PA gels for 16-24 hours prior to taking measurements. Before the measurements, the cells were transferred into serum-free CO₂-independent medium (Invitrogen™). In some samples, the actin cytoskeleton was disrupted with 200 nM cytochalasin D (Sigma Aldrich) for 15 minutes at room temperature in serum-free CO₂-independent medium.

### Example 4

Cell adhesion on a micropatterned PA gel was studied by immunofluorescence microscopy. Endothelial cells attached to micropatterned PA gels were fixed with 4% paraformaldehyde (Sigma Aldrich), permeabilized with 0.1% TritonX-100 (EMD Millipore) and rinsed with PBS. To prevent non-specific binding, PA gels were blocked with 1% bovine serum albumin (BSA) in PBS. Cells were labeled using a primary mouse anti-vinculin antibody (1:100, Invitrogen), followed by an AlexaFluor 488 anti-mouse secondary antibody (1:100, Invitrogen). Actin and nuclei were labeled using rhodamine phalloidin (16.5 nM, Invitrogen) and bisbenzimide (0.2 μg/mL, Invitrogen™), respectively. The PA gels with cells adhered thereto were imaged using an Olympus Fluoview 1000 confocal microscope.

### Example 5

A micropatterned single cell array adhered to a PA gel was mounted on an inverted Olympus IX81 fluorescent microscope. The quadrupole DEP device 100 was attached to a micromanipulator (Eppendorf), and the electrodes were centered and lowered over a single adhered cell within approximately ˜10 μm of the cell. Electrical potential was applied using a function generator (BK Precision 3011B) set to 20 Vpp, 1 MHz. The positive function generator lead was diverted into two separate lines, each going to a resistance decade box, before connecting to diagonally opposing device electrodes as in FIG. 2D. With no extra resistance applied, both electrodes received the same voltage. Increasing resistance to one electrode decreased voltage to that electrode and therefore changed the magnitude of the DEP force as well as the force direction. For each cell, DEP force was applied for 15 seconds, followed by 15 seconds with equal voltage across the electrodes.

Bright-field images were taken every 0.5 seconds throughout each measurement. Images were converted to binary black and white by Otsu's method, using MATLAB's Image Processing Toolbox (Mathworks). Image processing was conducted to isolate the cell body as the single connected component in the sequence of images. Cell deformation was quantified by measuring the distance between cell body centroid and the lower left corner of the cropped image. DEP pushing force was applied in the direction of the upper right corner of the image, causing this distance to increase as DEP force was applied. All measurements were then normalized relative to the initial position of the cell at the beginning of the pushing sequence.

### Example 6

Atomic force microscopy (AFM, Bioscope DAFM-2X, Veeco) was used to validate DEP device 100 cell stiffness measurements (elastic modulus). A silicon nitride cantilever with 1 μm spherical tip (196 μm long, 23 μm wide, 600 nm thick, spring constant 0.06 N/m, Novascan) was used to indent each measured cell at three distinct locations. Elastic modulus was estimated by fitting the first 200 nm of the indentation curves to a Hertz model (Solon et al., “Fibroblast adaptation and stiffness matching to soft elastic substrates,” Biophys. J., vol. 3, pages 4453-4461, 2007). Three measurements per cell were averaged and defined as the cell stiffness. At least six cells for each cell condition or cell type were measured.

### Example 7

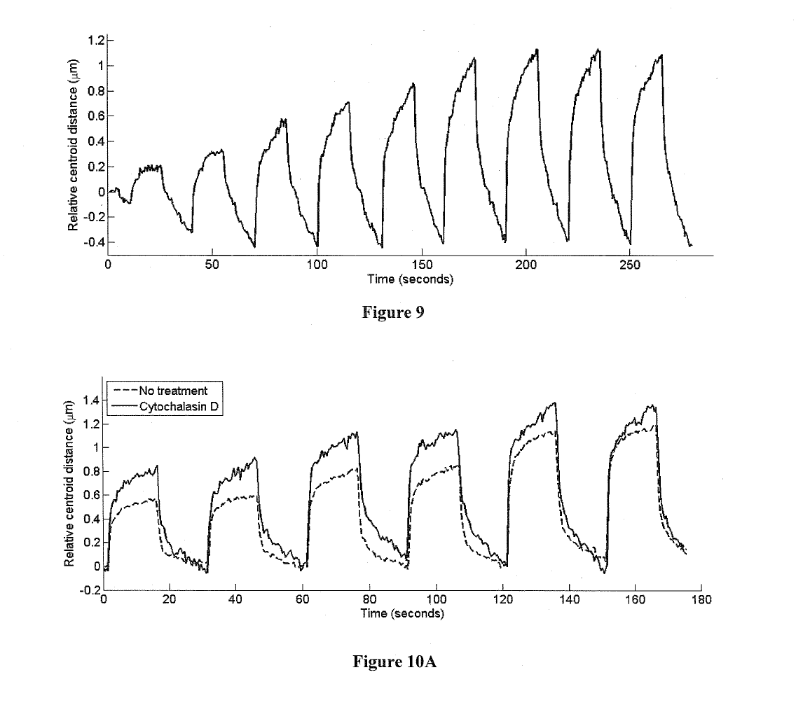

A single porcine aortic endothelial cell adhered to a PA gel was sequentially deformed using increasing DEP forces by increasing the voltage difference ΔV across opposing electrodes of the quadrupole electrode 4. When voltage was lowered on one electrode, the cell centroid moved toward the low voltage electrode, i.e. in the direction of the DEP force. When the same voltage was restored on both electrodes, the cell centroid recovered back towards its original position as shown in FIG. 9. As the voltage was lowered further on one electrode, and therefore the applied DEP force increased, the distance of the cell centroid movement also increased as shown towards the right side of FIG. 9.

### Example 8

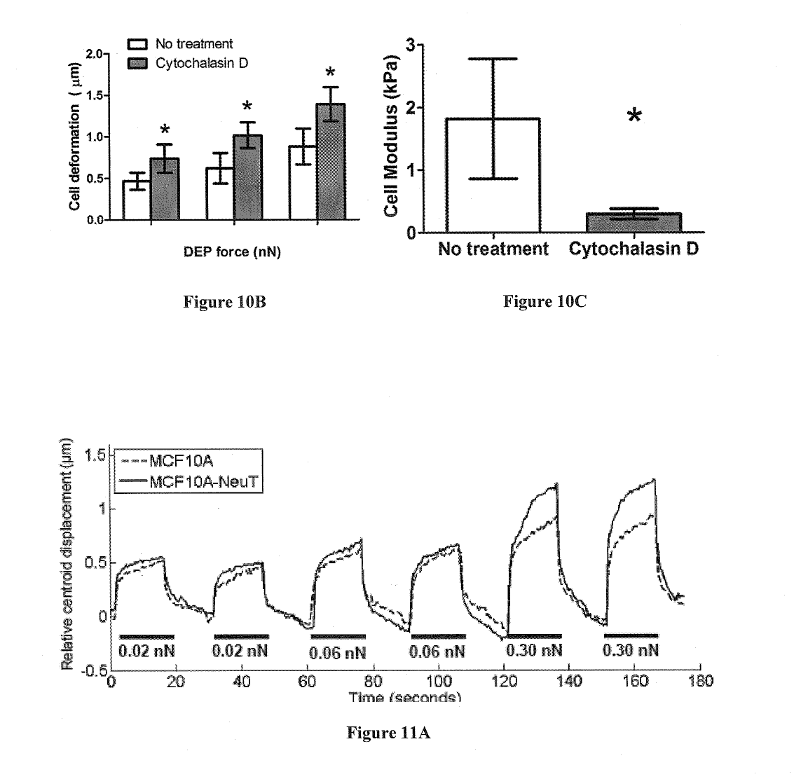

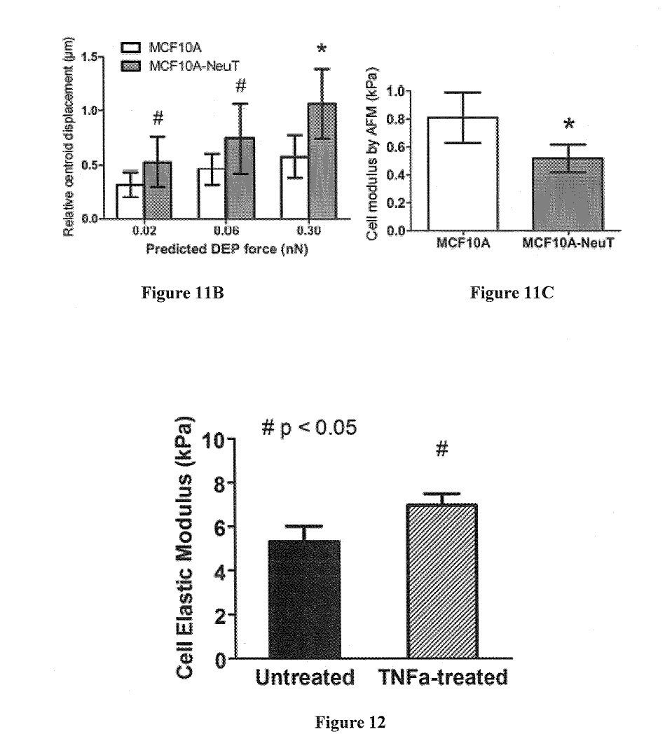

Adhered porcine aortic endothelial cells were treated with cytochalasin D to determine the stiffness changes induced by cytochalasin D using the DEP device 100 of the present invention. The adhered porcine aortic endothelial cells were treated with 200 nM cytochalasin D for 15 minutes. Untreated endothelial cells showed centroid deformations consistently smaller than treated endothelia cells. Cell centroid restoration to the center position was slower in cytochalasin treated cells as shown in FIGS. 10A and 10B). AFM confirmed that cytochalasin treatment decreased the stiffness of the endothelial cells. The calculated cell elastic modulus in cytochalasin treated cells was about 0.3 kPa, while the cell elastic modulus in the untreated cells was calculated to be about 1.8 pKa (FIG. 10C).

### Example 9

The DEP device 100 of the present invention was used to measure cell stiffness of normal (MCF10A) and cancerous (MCF10A-NeuT) breast epithelial cells. MCF10A-NeuT cancer cell centroid deformation was higher than cell centroid deformation of MCF10A normal cells, with larger differences at higher applied DEP forces (FIGS. 11A and 11B). The measurements made using the DEP device 100 were confirmed by AFM. The modulus of MCF10A-NeuT cancer cells was determined to be about 0.5 kPa, lower than the modulus of MCF10A normal cells (about 0.75 kPa, FIG. 11C). This example confirms that the DEP device 100 can measure cell stiffness differences among different cell types, such as cancerous and normal cells.

### Example 10

Endothelial cells were cultured for 24 hours on micropatterned PA gels with stiffness of 55 kPa using 25 μm fibronectin circles as the microspots 8 to allow focal adhesion formation. The micropatterned PA gel was used in a DEP device 100 of the present invention provided with a microfluidic chamber 14. The quadrupole electrodes 4 were lowered with a single cell aligned within the cage of each quadrupole electrode 4. TNF-α was introduced to the microfluidic chamber 14 to expose the cells thereto. Cell stiffness or cell elastic modulus of the endothelial cell after TNF-α treatment was measured using AFM. Increased endothelial cell stiffness was observed after TNF-α treatment as shown in FIG. 12.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A quadrupole dielectrophoresis device (100) for deformation of adhered cells comprising:
a matrix (6) having a surface,
at least one microspot (8) comprising a cell-adherent protein located on the surface of said matrix (6),
at least one quadrupole electrode (4) including four electrodes and being positionable to locate at least one said microspot (8) in a location where a dielectrophoretic force can be exerted by said quadrupole electrode (4), and
a device for applying a voltage to at least two of said electrodes of said quadrupole electrodes (4), said device being capable of varying the voltage applied to at least one of said electrodes of said quadrupole electrode (4).

2. The quadrupole dielectrophoresis device (100) of claim 1, wherein the one or more quadrupole electrodes (4) comprise a material selected from the group consisting of silver, gold, cobalt, chromium, copper, iron, iridium, aluminum, nickel, tantalum, titanium, tungsten, titanium, platinum, palladium, vanadium, tantalum oxide, titanium oxide, chromium oxide, vanadium oxide, magnesium oxide, indium tin oxide, and combinations thereof.

3. The quadrupole dielectrophoresis device (100) of claim 2, wherein the matrix (6) comprises a material selected from glass, quartz, and a polymeric material.

4. The quadrupole dielectrophoresis device (100) of claim 3, wherein the protein comprises at least one protein selected from the group consisting of collagen I, collagen III, collagen IV, collagen VI, fibronectin, vitronectin, serum albumin, laminin, tenascin, fibrin, cadherin, filamin A, vimentin, decorin, tenascin C, osteopontin, and combinations thereof.

5. The quadrupole dielectrophoresis device (100) of claim 1, comprising a plurality of microspots (8) and a plurality of quadrupole electrodes (4).

6. The quadrupole dielectrophoresis device (100) of claim 5, wherein the distance between the microspots (8) is in a range of from about 50 μm to about 200 μm, or from about 70 μm to about 150 μm, or from about 80 μm to about 130 μm, or from about 90 μm to about 120 μm, or from about 100 μm to about 110 μm.

7. The quadrupole dielectrophoresis device (100) of claim 5, wherein the matrix (6) comprises a protrusion at a location of each of the microspots (8).

8. The quadrupole dielectrophoresis device (100) of claim 5, wherein the matrix (6) is flexible.

9. The quadrupole dielectrophoresis device (100) of claim 8, wherein the matrix (6) has a different stiffness at different locations of said matrix (6) such that at least some microspots (8) are located on areas of the matrix (6) having different stiffness.

10. The quadrupole dielectrophoresis device (100) of claim 9, wherein the stiffness of the matrix (6) increases from one end of the matrix (6) to another end of the matrix (6) such that at least some microspots (8) are located on areas of the matrix (6) having a plurality of different stiffness.

11. The quadrupole dielectrophoresis device (100) of claim 5, wherein one set of the microspots (8) comprises a first protein and another set of the microspots (8) comprises a second, different protein.

12. The quadrupole dielectrophoresis device (100) of claim 5, further comprising an electric cell-substrate impedance sensing system for measuring cell deformation.

13. The quadrupole dielectrophoresis device (100) of claim 5, further comprising a phase contrast microscope for measuring cell deformation.

14. The quadrupole dielectrophoresis device (100) of claim 5, further comprising a microfluidic chamber (14) positioned to create a flow that contacts cells adhered to said microspots (8).

15. The quadrupole dielectrophoresis device (100) of claim 5, wherein the quadrupole electrodes (4) are multiplexed with the device (100) for applying a voltage to permit different voltages to be simultaneously applied to different electrodes.

16. The quadrupole dielectrophoresis device (100) of claim 15, wherein electric cell-substrate impedance sensing system is connected for simultaneous measurement of cell impedance at a plurality of different microspots (8).

17. A method of analyzing cell mechanics of an adhered cell comprising steps of:
adhering (102) at least one cell to at least one microspot (8) of the quadrupole dielectrophoresis device (100) of claim 1,
applying (104) a voltage to at least two of said four electrodes of each said quadrupole electrode (4) to exert a dielectrophoretic force on said at least one adhered cell, and
determining (106) at least one property of said cell during exertion of said dielectrophoretic force.

18. The method of claim 17, further comprising a step of exposing the at least one adhered cell to a substance or fluid flow prior to or during said determining step.

19. The method of claim 17, wherein the at least one property of said cell is selected from the group consisting of cell stiffness, cell deformability and Poisson's ratio.

20. The method of claim 17, wherein the at least one property of said cell is selected from the group consisting of resistance, capacitance and impedance.
